(19) United States
(12) Patent Application Publication
(10) Pub. No.: US 2014/0173105 A1
(43) Pub. Date: Jun. 19, 2014

(54) MANAGEMENT OF INFORMATION-TECHNOLOGY SERVICES

(71) Applicants: Daniel Sarfati, Raanana (IL); Tanya Epstein, Barkan (IL); Bradley Joseph Hlista, Volente, TX (US); Robert Jon Harrington, Golden, CO (US); Samir Varma, Cos Cob, CT (US)

(72) Inventors: Daniel Sarfati, Raanana (IL); Tanya Epstein, Barkan (IL); Bradley Joseph Hlista, Volente, TX (US); Robert Jon Harrington, Golden, CO (US); Samir Varma, Cos Cob, CT (US)

(21) Appl. No.: 14/133,550

(22) Filed: Dec. 18, 2013

Related U.S. Application Data
(60) Provisional application No. 61/739,623, filed on Dec. 19, 2012.

(51) Int. Cl. H04L 12/26

(52) U.S. Cl. CPC H04L 43/04
USPC 709/224

(57) ABSTRACT

A system includes a collection module configured to collect data characterizing usage of a plurality of software applications hosted on a network by users of a set of client devices, a data-storing module configured to store the collected data, and a processing module configured to determine, based on the stored data, at least one usage metric for each of the plurality of software applications.

### PRIORITY CLAIM

The present application claims priority from U.S. Provisional Application No. 61/739,623, filed Dec. 19, 2012, which is incorporated by reference as if fully set forth herein.

### BACKGROUND

Traditional management of information technology (IT) processes is based on managing hardware and software (HW and SW) running on premises. IT managers need to dimension networks, then servers, and then devices (workstations or PCs). Once the infrastructure is in place, their attention turns to the SW that must be installed on the infrastructure. In this scenario, SW versions are periodically updated by the vendor and sold again as a new product.

Primary challenges of managing traditional IT are twofold:

Make sure the infrastructure keeps working at an acceptable service level

Select, maintain and update the SW

The univocal relation between SW and devices is so strong that SW vendors to this day sell SW licenses based on the number of installations on PCs. Floating licensing is a software licensing approach in which a limited number of licenses for a software application are shared among a larger number of users over time. When an authorized user wishes to run the application they request a license from a central license server. If a license is available the license server allows the application to run. When they finish using the application, or when the allowed license period expires, the license is reclaimed by the license server and made available to other authorized users.

The advent of cloud computing has caused a significant change in the way IT is managed in the enterprise, as SW runs on remote servers and is accessed through browsers. Cloud computing is the use of computing resources (hardware and software) that are delivered as a service over a network (typically the Internet).

Responsibility for maintaining and upgrading SW moves to the SW vendors. Vendors manage also the servers running their SW and as a result enterprise IT management responsibility is reduced only to make sure internal users have enough connectivity to the remote servers to guarantee a smooth work and devices on which to connect. SW is sold as a service (SaaS—Software as a Service): the most common model is the one of monthly subscriptions.

The vast majority of SaaS applications are sold under a “named subscription” model. This means that subscriptions to SaaS applications are in reality assigned to subscribers or users, real persons that are uniquely identified by the vendor, usually through their e-mail address (a unique identifier). SaaS applications run on remote servers and are accessed through a browser. Consequently, they can be accessed through a vast range of devices. The traditional univocal relation between user and device no longer applies.

Actual usage becomes critical in a reality where applications are no longer selected by IT managers but by the users themselves, often without IT managers being asked or even being aware of their use within their enterprise. The IT asset management approach proposed by several vendors can help in managing subscription assignment to users but cannot provide information on actual application usage. Almost by definition it cannot provide information on subscriptions that were not assigned by the same IT management.

The current service-device paradigm doesn't explain efficiently the IT world anymore since it ignores the fact that users access applications through different devices and because it ignores the importance of actual usage. Accordingly, it would be beneficial to have a system and/or method by which IT managers can easily measure and analyze SaaS usage across a company or other organization.

### BRIEF DESCRIPTION OF THE DRAWINGS

Preferred and alternative embodiments of the present invention are described in detail below with reference to the following drawing figures.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a functional block diagram of an exemplary operating environment in which an embodiment of the invention can be implemented;

FIGS. 4-6 illustrate alternative embodiments of the invention in which data may be collected; and

FIGS. 7-10 illustrate multiple graphic usage analyses that may be generated according to at least one embodiment of the invention.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention provide features including a universal mechanism to support various authentication mechanisms introduced by cloud applications, environment and convenient tools for IT people to manage cloud applications subscriptions and to provision and de-provision applications, device-independent usage tracking, location-independent usage tracking, development tools, and SOA and open source integration scripts with various cloud-application vendors.

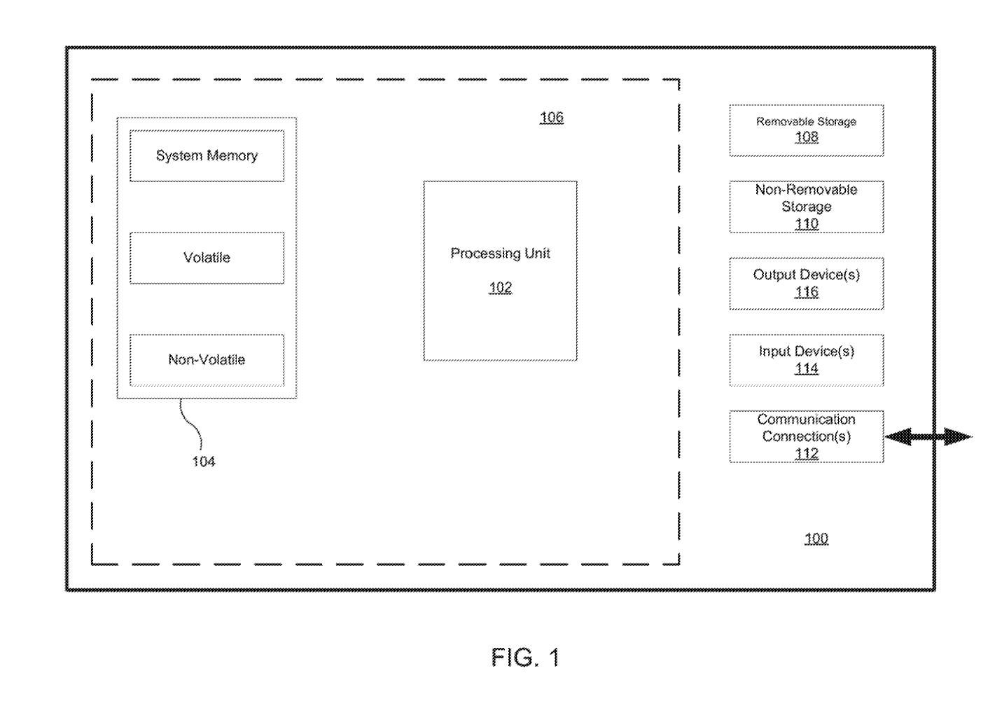

FIG. 1 illustrates an example of a computing system environment 100 in which an embodiment of the invention may be implemented. The computing system environment 100, as illustrated, is an example of a suitable computing environment; however it is appreciated that other environments, systems, and devices may be used to implement various embodiments of the invention as described in more detail below.

Embodiments of the invention may be implemented in hardware, firmware, software, or a combination of two or more of each. Embodiments of the invention may be operational with numerous general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices.

With reference to FIG. 1, an exemplary system for implementing an embodiment of the invention includes a computing device, such as computing device 100. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

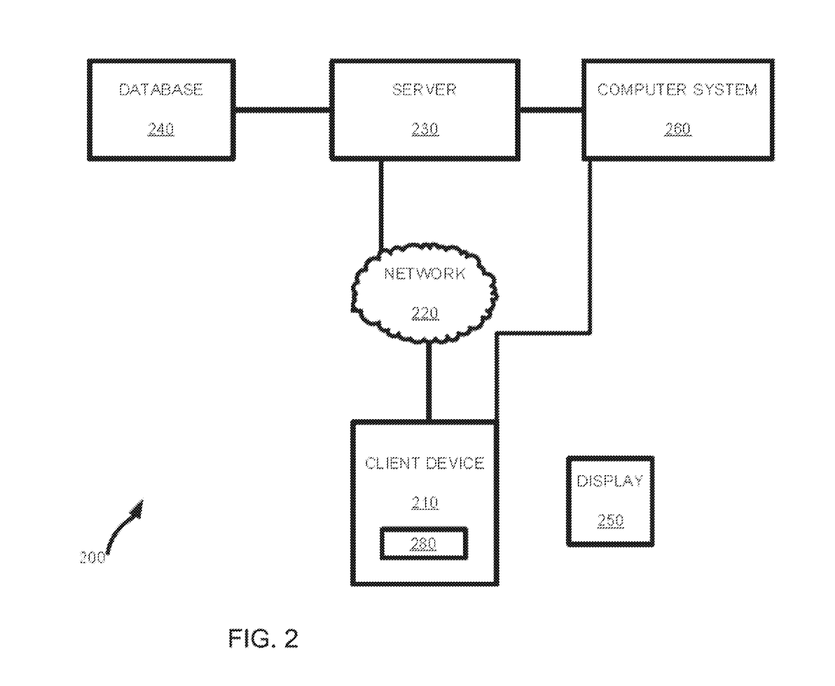

Referring now to FIG. 2, an embodiment of the present invention may take the form, and/or may be implemented using one or more elements, of an exemplary computer network system 200. The system 200 includes an electronic client device 210, such as a personal computer or workstation, tablet or smart phone, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 includes or is otherwise coupled to a computer screen or display 250. The client device 210 may be used for various purposes such as network- and local-computing processes.

The client device 210 is linked via the network 220 to server 230 so that computer programs, such as, for example, a browser, running on the client device 210 can cooperate in two-way communication with server 230. The server 230 may be coupled to database 240 to retrieve information therefrom and to store information thereto. Database 240 may have stored therein data (not shown) that can be used by the server 230 to enable performance of various aspects of embodiments of the invention. Additionally, the server 230 may be coupled to the computer system 260 in a manner allowing the server to delegate certain processing functions to the computer system. In an embodiment, the client device 210 may bypass network 220 and communicate directly with computer system 260.

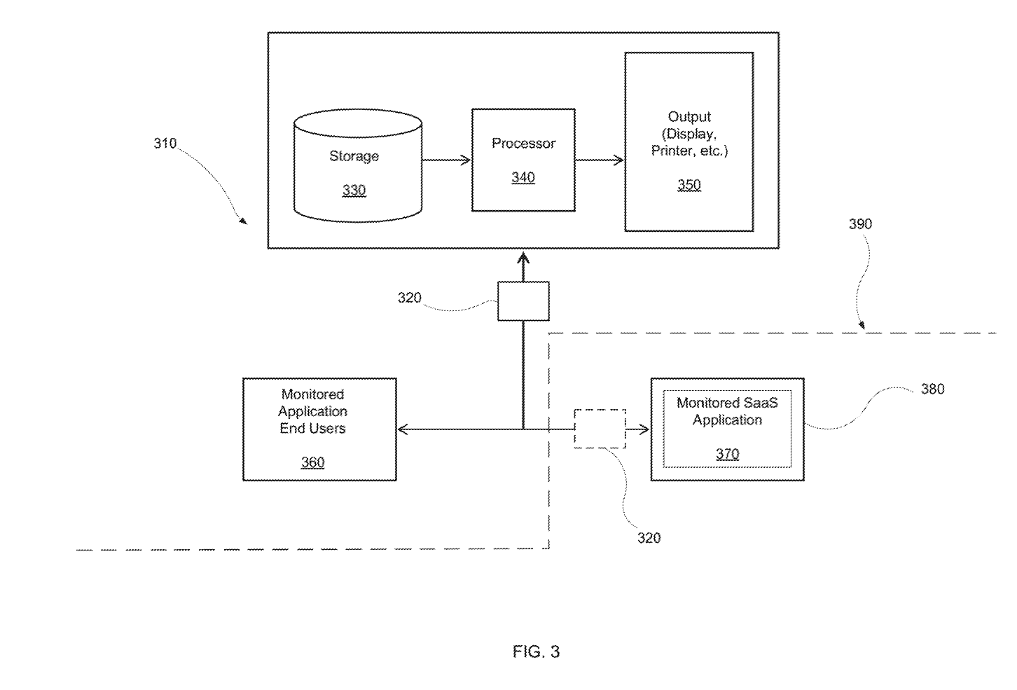

FIG. 3 illustrates a system 310 according to an embodiment of the invention, and the elements illustrated in FIG. 3 may be identical, or otherwise function in a manner similar, to elements described above with reference to FIG. 2. System 310 includes an application adaptor 320, serving as a collection module, a memory device, such as a storage module 330, and a processing module (processor) 340. As will be discussed in greater detail below, the adaptor 320 is configured to interact with a set of client devices 360 employed by end users and/or a plurality of software applications 370 (i.e., SaaS applications) hosted on a network including one or more servers 380. In an embodiment, adaptor 320 is an application-specific component that can be configured to recognize or otherwise discover the object model of and operation(s) that can be applied on specific object types by a targeted application 370. Additionally, adaptor 370 is configured to convert the specific object language of application 370 into a generic model according to an embodiment.

Elements of one or more embodiments of the system 310 may be situated behind a firewall 390 with respect to the servers 380, as is the case with the embodiment illustrated in FIG. 3. As also shown in FIG. 3, adaptor 320 may be positioned on either side of firewall 390 relative to the monitored end users 360. Alternatively, elements of a unitary embodiment of the adaptor 320 may be configured to “straddle” the firewall 390.

In the illustrated embodiment, the adaptor 320 is configured to collect data characterizing usage (“usage data”) of the SaaS applications 370 hosted on the one or more servers 380 by the end users employing the client devices 360. The collected data is subsequently stored in the storage module 330. As will be discussed in greater detail below, the processor 340 is configured to determine, based on the stored data, at least one usage metric (such as, for example, a rating) for each of the client devices 360 (i.e., end users) and/or plurality of software applications 370. The determined usage metric is then made viewable via an output device 350, such as a display or printer, for example.

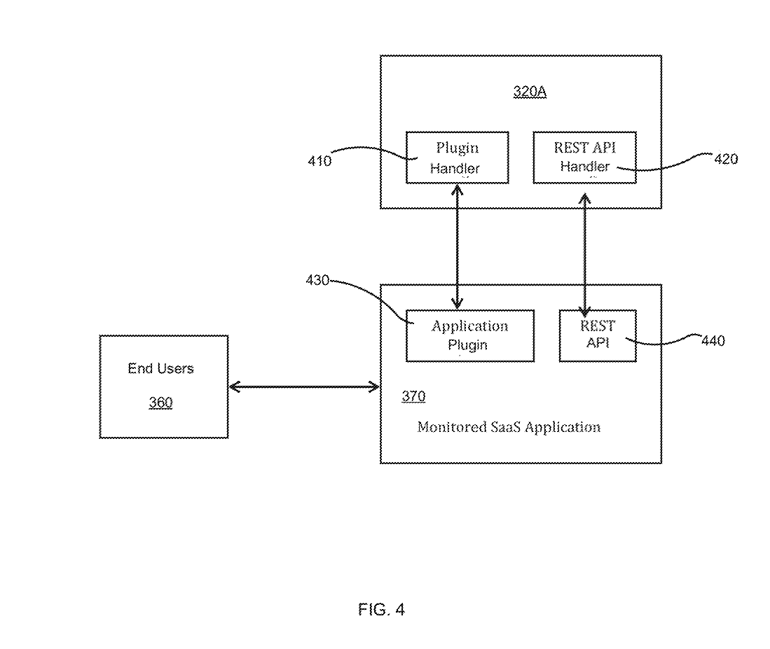

The type of usage data collected by the adaptor 320, as well as the manner in which such data is collected, may vary depending the particular embodiment employed. For example, referring to FIG. 4, an adaptor 320A of an embodiment may include a plugin handler 410 and a Representational State Transfer (REST) API handler 420 configured to respectively and communicatively interface with a plugin 430 and REST API 440 associated with an application 370. Such an arrangement enables the adaptor 320A to collect directly from an application 370 data characterizing the usage of such application by one or more client devices 360.

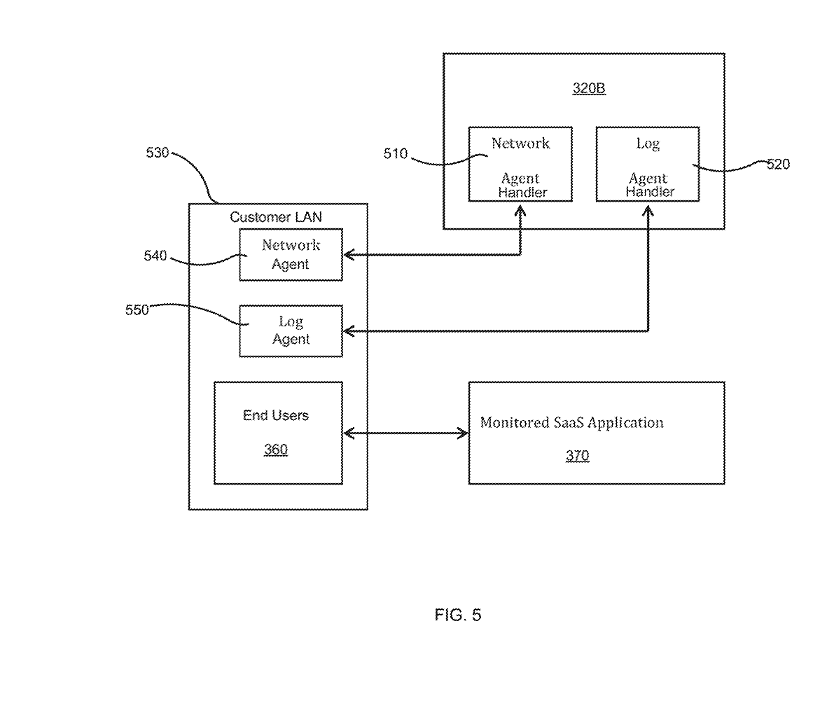

Referring now to FIG. 5, an adaptor 320B of an embodiment may include a network agent handler 510 and a log agent handler 420 configured to respectively and communicatively interface with one or more network agents 540 and log processing agents 550 associated with a local-area network (LAN) 530 (or wide-area network (WAN)) of which the client devices 360 are constituent elements. Such an arrangement enables the adaptor 320B to collect data characterizing the usage of an application 370 by one or more client devices 360 from elements of the LAN 530 (which may be behind a firewall 390 relative to a server 380 hosting the application) rather than the application itself

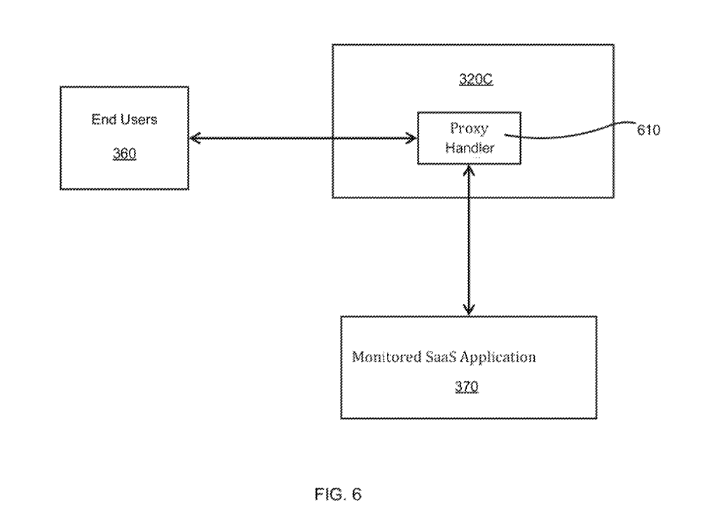

Referring now to FIG. 6, an adaptor 320C of an embodiment may include a proxy handler 610 configured to communicatively interface with the client devices 360 and application 370. Such an arrangement enables the adaptor 320C to collect directly from one or more client devices 360 and application 370 data characterizing the usage of such application by the one or more client devices.

The embodiments illustrated and described above are configured to collect a variety of usage statistics from multiple SaaS applications 370. As above alluded to, these statistics may come from the SaaS applications themselves, via communication directly with the application, application REST APIs or application plugins, agents monitoring network traffic, system logs, application logs, network logs, VPN logs, firewall logs, network proxy services, application-user email, and/or company billing systems.

The collected usage statistics may be unique for each application 370 and could include items such as:

1. number of logins,

2. time since last login,

3. total application usage time,

4. number of times an application object was read,

5. number of times an application object was written or modified,

6. number of bytes sent/received,

7. number of packets sent/received,

8. number of application objects created,

9. number of pointer “clicks” associated with application usage.

The multiple methods of collection allow one or more embodiments to capture data across a variety of client devices 360 and/or through integration with SaaS vendors' logs and associate with specific users, resulting in device- and location-independent usage statistics.

All usage data collected by adaptor 320 may be stored in storage device 330 for future retrieval and analysis. Storage device 330 may consist of one or more of a relational database, “NoSql” type database, and flat files. Given the variety of SaaS applications 370 and data types collected, an embodiment may use some combination of semi-structured or unstructured data stores such as NoSql databases and flat files.

In an embodiment, data stored in device 330 is analyzed and formatted by an analytic engine, according to an embodiment, executed by processor 340 and using metadata associated with applications 370 and/or a behavioral model associated with one or more of end users 360. Such data may be retrieved and analyzed in a distributed manner. Given the semi-structured or unstructured nature of the data, in an embodiment, techniques may include big data frameworks such as MapReduce.

A variety of usage analytics may be computed for applications 370:

1. on an individual application basis,

2. combined across multiple applications, and/or

3. combined across company departments or business units.

These usage analytics can be computed and/or monitored over time (including a predetermined time duration and/or specific time period) by processor 340 allowing for usage trend analysis. A usage metric for each application may be computed based on collected statistics pertaining to an application 370. This usage metric may be different for each application 370.

An exemplary calculation of such a usage metric is in the case where the statistics of interest are:

1. L=number of logins,

2. R=number of read accesses,

3. W=number of write/modify accesses.

An embodiment may classify an application user 360 over a specified unit time period (e.g., one day) as follows:

1. Full Access User: if (L>0, W>0) then FA=1, else FA=0,

2. Read Only User: if (L>0, R>0, W=0) the RO=1, else RO=0,

3. Non User: if (L=0) then NU=1, else NU=0.

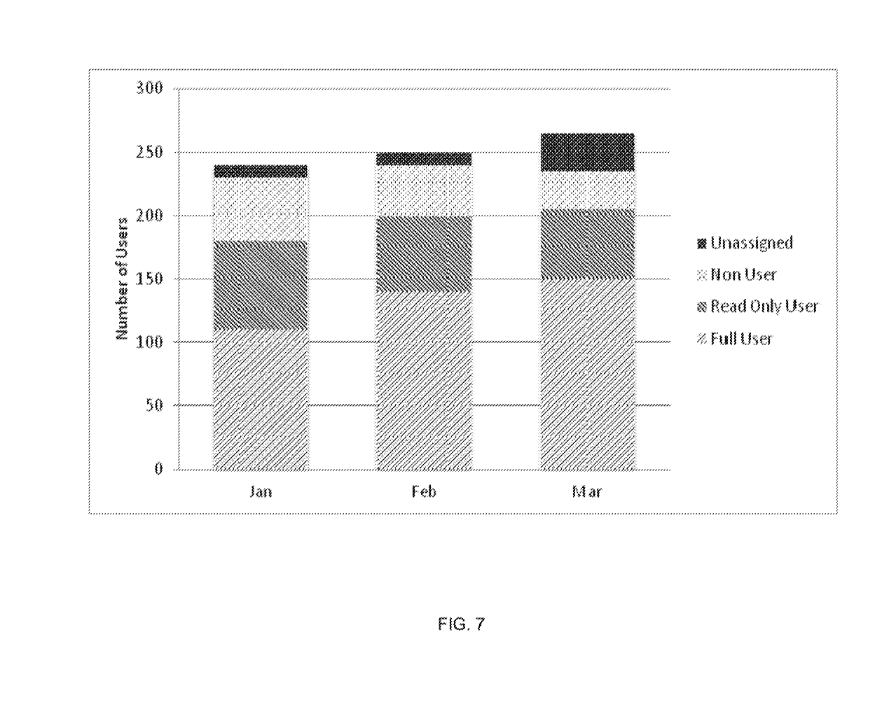

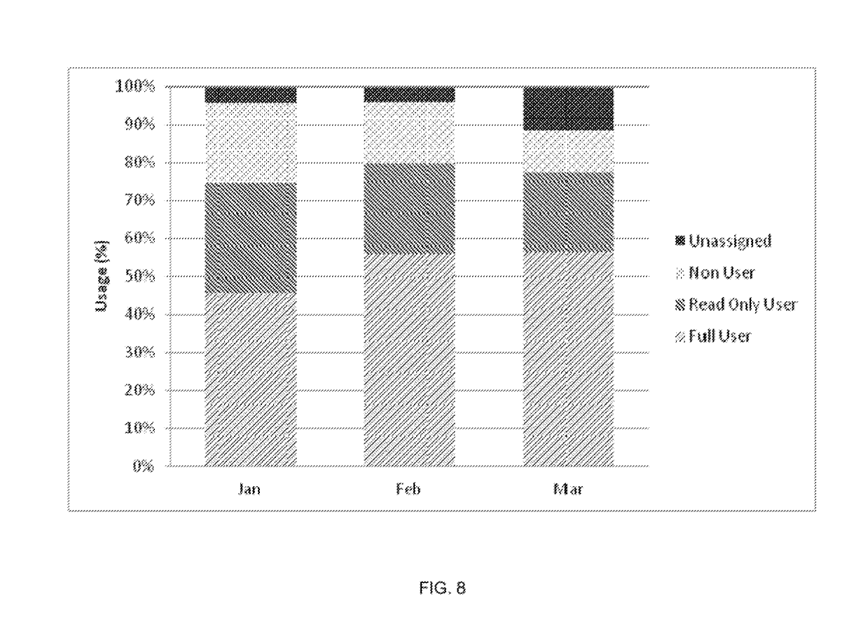

Consequently, simple usage statistics can be presented by output 350 on an absolute or percent basis, as are illustrated in FIGS. 7 and 8, respectively.

An embodiment can also compute a normalized usage rating that allows for easier comparison between applications. For a given user, Ux, a usage rating for that user 360 over N number of unit time periods can be computed according to Equation 1:

$${U}_{x} = 1 / N {{\sum }_{i}}^{N} ( 10 * {FA}_{i} + 5 * {RO}_{i} ) \qquad ( 1 )$$

Note that, in alternative embodiments, the factors 10 and 5 in the above formula could be replaced with arbitrary weighting factors to set overall scale and relative weight. A usage rating for the organization with M application users 360 may be computed according to Equation 2:

$${U}_{total} = 1 / M {\sum }_{x}^{M} {U}_{x} \qquad ( 2 )$$

This provides an organization-wide usage rating for that application on a scale of 0-10.

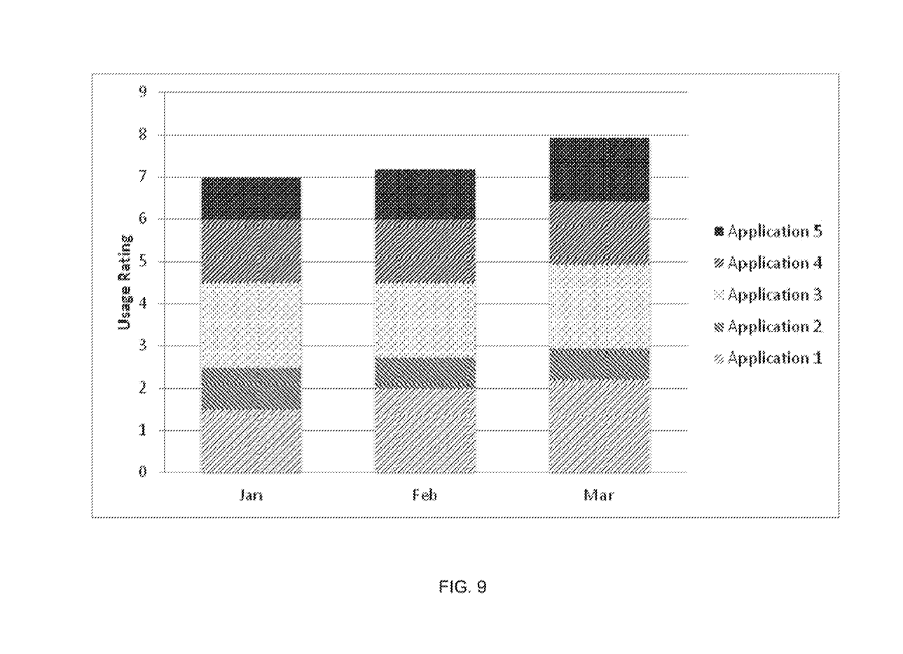

Similar “normalized” usage ratings can be developed for each application 370 being managed and those usage ratings combined to give an overall company-wide SaaS usage rating, as is illustrated in FIG. 9.

In the case of SaaS application “mashups”, whereby different SaaS applications are combined to create a new SaaS application, an embodiment can combine usage analytics of the underlying applications to create new usage analytics for the mashup application.

In an alternative embodiment, average accumulated Usage Index and Activity Level (KPIs) may be calculated and stored, as follows:

Per application assignee—user having direct assignment of application subscription. Calculated Usage Index and Activity Level are kept in the object of application subscription.

Average per user for all assigned applications—sum of corresponding KPI per applications divided by number of assigned applications. Calculated average Usage Index and Activity Level are kept in the User object.

Average per User Group for all applications—is calculated as an average between all members with utilization criterion other than 0. Calculated average Usage Index and Activity Level are kept in the User Group object.

Average per application—average of all assignees—users divided by the number of assignees. Calculated average KPIs are kept in the Application object.

Average per organization—average of all application assignees (sum of all subscriptions that should undergo calculation divided by number of such subscriptions)

Subscriptions that should undergo calculation are those subscriptions that have assignee with utilization criterion other than zero (0).

Criteria Definition

Criteria may be provided in the form of predefined templates:

Template 1:

<number of logins> in <number><period>

Template 2:

<number of logins> every <number><period>

<number of logins> can be in the range of 1 . . . 9

<number> of <period> can be in the range of 1 . . . 9

<period> can be represented by Day, Week, Month

Each criterion is represented by text description, which is shown in the UI.

Solution provides users with a set of predefined criteria, such as

at least once a day—(1 in 1 day)

at least once a week—(1 in 1 week)

at least once a month—(1 in 1 month)

at least twice a week (month)—(2 in 1 week)

at least three times a week (month)—(3 in 1 week)

at least one login every second day—(1 every 2 days)

once a while (0 in any period)

others

In the first version of the product an embodiment provides customers with a wide range of predefined Usage Utilization criteria. Customers are allowed to define their own Usage Utilization criteria.

Calculation Algorithm

The following is one of the possible algorithms according to an embodiment to calculate Usage Index and Activity Level per application/application assignee:

1. Calculate DayCriterion by normalizing expected criteria to Daily representation. For example:

Once a day=1

Once a Week=1/NoOfWorkDaysaWeek=0.2

Twice a Week=2/NoOfWorkDaysaWeek=0.4

Note: only working days are taken into consideration according to an embodiment.

2. Calculate DayLogins of the user—number of logins normalized to one day.

DayLogins=NoOfLoginsInPeriod/NoOfWorkDaysInPeriod (see also DayLogins calculation below).

3. Usage Index is calculated as:

UsageIndex=DayLogins/DayCriterion*100%

4. Activity Level is equal to:

a. High Utilization—If Usagelndex>75%

b. Medium Utilization—if 25%>=Usagelndex=<75%

c. Low Utilization—if UsageIndex<25%

NoOfLoginsInPeriod is taken from the System log for all days—working and not working Several logins within one day should be represented by “1”.

DayLogins Calculation

Accumulated criterion per application and application assignee is represented in the corresponding Subscriptions object in the following five fields:

Usage Index

Activity Level

No of working days in statistic sample

No of logins in a sample

Start Sample date

To calculate accumulated KPIs, an embodiment calculates accumulated DayLogins by:

Incrementing number of working days in statistic sample (only for working days);

Incrementing number of logins in a sample in case there was at least one login of the assignee within the calculation day

An embodiment may take into account that statistics should be accumulated in the very beginning If number of working days in statistic sample is still less than “expected period*2” the result of the calculation may not be shown to the user. Usage Index and Activity Level in these cases should be equal to the number (for instance, negative) that tells client not to show the value in the UI.

DayLogins=No. of logins in a sample/No. of working days in statistic sample.

If Today—Start Day of sample>Year—No of working days in statistic sample:=0 and No of logins in a sample:=0.

Calculation Job

Job that calculates average accumulated KPIs may run for every organization's time zone at midnight. For nonworking days the job may behave differently for the two following cases:

If assignee did not login an application, job may not recalculate the KPIs for corresponding application.

If assignee logged in at least once, job may calculate KPIs without incrementing the No. of working days in statistic sample.

In an embodiment, customers (i.e., an organization of which end users 360 are constituents) may have access to their own detailed usage analytics. An embodiment can provide benchmarking across organizations and/or versus other organizations or groups of organizations and targeted usage goals for customers. An embodiment may be able to combine this information with SaaS license pricing to provide customers with internal SaaS spending budget allocation: e.g., to departments, locations and business units.

In addition to computing and reporting usage analytics for individual customers, an embodiment may compute analytics involving multiple customers' usage data in an anonymized fashion. This allows an embodiment to:

catalog which SaaS applications are in use,

determine how applications rank relative to their competitors, overall and in vertical markets,

quantify “Industry Best Practices” relating to SaaS application usage,

provide customers with their relative industry ranking and recommendations for improvements,

show favorite applications for specific functions across enterprises,

market and sell aggregated usage data for specific applications or for classes of applications, to be used as reference to compare performance levels by enterprises and/or for auditing purposes,

discover SaaS applications or usage unknown to company.

An embodiment may determine who is using an application for purposes of identifying who are the existing users of each unknown (or even known) application 370. Such function may provide information about how many users 360 there are for each application 370 and about their volume of usage.

As alluded to above herein, methods to achieve this functionality may, according to one or more embodiments, be as follows:

1. Examining network traffic, an embodiment could “discover” users that were not in the official licensing of the company; for example, an employee that purchased a license individually using a credit card.

2. Examining logs from firewalls to see which applications 370 were being accessed from which devices 360 and geolocating those devices.

3. Examining logs from routers for the same purpose.

4. Examining VPN logs for the same purpose.

5. Installing a client application to monitor outgoing traffic on a mobile device.

6. Using the per application VPN in iOS to monitor outgoing traffic for this purpose.

An embodiment may integrate the above-described information for analysis by processor 340.

An embodiment may be configured to generate a list of “known users” against which to compare collected data. This could be achieved by examining a user database such as Active Directory or LDAP, which would then be compared to the discovery described above. Reports to output device 350 may then be generated. One class of reports could then be based on SaaS usage that does not match with this list of users.

At the network level, there may be complications with seeing exactly what users are doing but an embodiment can arrive at one type of usage stats based simply on the traffic volume (either packets or bandwidth) associated to each user 360 of a particular application 370. This usage or activity mapping may be different for each application 370 and may involve some research to determine.

An embodiment includes a method to discover which paid applications are in use within the organization by users 360. The basic consideration is that every SaaS provider sends periodic invoices to its customers via email; invoices are obvious proof of the organization using a service. With a customer's permission, and by searching a customer's entire mail server, an embodiment may extract information about which SaaS applications 370 have been contracted for by end users 360 at that customer. One such embodiment is by comparing an email database to invoice emails sent by known SaaS vendors. An embodiment may then find SaaS services contracted for, and match them to users 360 (the users to which the emails are addressed). Those users 360 are also the “internal owners” of those services, because they are the billing counterparty for the SaaS vendor.

An embodiment is able to recognize invoices sent by specific vendors. The output may be a list of all those invoices that an embodiment recognizes that are from SaaS vendors providing services to the organization. An embodiment may extract at least some minimal information from the content of the invoices, such as the total amount due and invoice date.

An embodiment may also be able to determine the number of licenses purchased, their duration or renewal and other relevant data.

In an embodiment, email received in the past year is screened since all vendors, even the ones with a multi-year plan, send at least one invoice a year to their customers. An embodiment then collects this information and presents it to customers after the initial analysis and without need to wait for a customer to run an embodiment for a few weeks in order to perceive some value. It would also prove history of billing for the same customer by the vendors.

In short, an embodiment may present a list of users 360, a detail of the applications 370 in use and the amount spent in the past and/or, by extrapolation, a forecast to be spent in the future.

An embodiment monitors what applications 370 are being used to enable customers to improve their efficiency and spending.

An embodiment provides analytics and reporting related to the utilization of SaaS licenses, which will help companies with budgeting and expense control. An embodiment may collect and store SaaS application user and matching license information. Linking this data with usage analytics will allow for advanced subscription management including addition/removal of licenses, assignment of licenses, license renewals, reporting of unused licenses, and reporting of improperly assigned or allocated licenses.

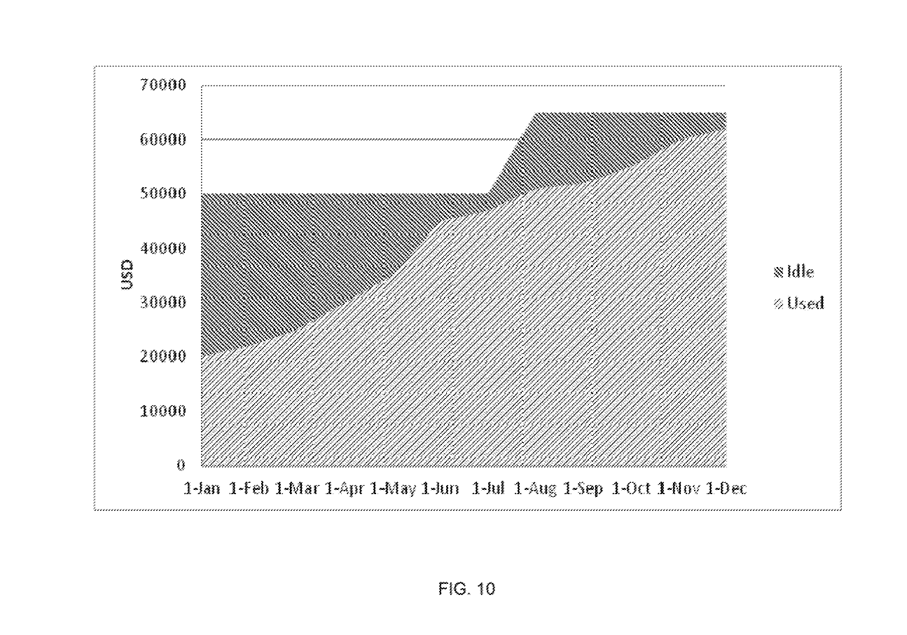

An embodiment can compute a license spending efficiency that shows how much SaaS spending of the organization that includes users 360 is remaining idle at any given time and help them plan to minimize the waste, as is illustrated in FIG. 10.

An embodiment may collect and store SaaS application 370 pricing models. This information may come from multiple sources including publically available sources and anonymized information from customer licensing data. An embodiment can then provide a variety of analytics on these SaaS pricing models and how they impact a customer's deployments. Two examples include computing the optimal cost of an application for a company based on usage and computing the optimal cost for multiple applications in the same category (e.g., showing a company their optimal deployment of three different SaaS storage applications 370 based on the available licensing and types of usage across the company).

An embodiment may provide mechanisms for provisioning/de-provisioning users on the managed SaaS applications 370. This provisioning information could be entered into an embodiment directly or it could come through integration with user databases such as Active Directory or LDAP.

An embodiment may provide employee lifecycle management of SaaS applications 370. An embodiment may monitor employees' status at the company via their SaaS provisioning and usage. An embodiment may be able to provide reports and alerts if, for example, an employee is de-provisioned in one or more applications 370, as that may be a sign they have left the company and they need to be de-provisioned in other applications.

An embodiment may use the data collected from within an organization, in order to benchmark that organization to others. This will show the organization where it stands with respect to its efficiency in utilizing SaaS applications as compared to its peers.

An embodiment may include “time and motion” analysis. A large component of the cost of software is, besides the licensing cost, the cost of the time spent by its users. An embodiment may measure how efficient software is at enabling users to do their jobs. For example, what is the optimal time spent by a salesperson on salesforce.com? This is because the cost of a salesforce.com license is not just the up-front software cost, but also the cost of the time spent by salespersons entering data and looking up reports. How much input does the software require and at what cost? For this cost of input, what outputs does the software enable?

Due to provisioning capabilities, an embodiment may enable users not just to bring their own devices (BYOD), but also allow them to choose which SaaS applications they prefer to get their jobs done (BYOS=Bring your own SaaS).

To the extent that more than one user is using a SaaS application in read-only mode, an embodiment may provide a means for all those users to share one login, thus enabling the organization to cut down on its software costs.

An embodiment may provide usage analytics services to multiple customers. In this case a system integrator (SI) will have a higher-level view of usage of applications by several of its enterprise customers. SI's customers have to be completely separated from a logical point of view and not able to see each other, while on the other hand the SI shall be limited in viewing usage only for a subset of the Enterprises' applications. Example: a Google Applications SI can see usage for all his customers using Google Applications but not Salesforce usage.

By integrating directly with the SaaS applications 370 using customers' credentials, an embodiment may sync the users 360 and be able to provision and de-provision users. This is a lightweight provisioning system that completely bypasses the traditional SSO-Identity Management model. In addition, once an embodiment uniquely identified a user 360 through his/her email address (the unique identifier) an embodiment can then connect/provision that user to any application 370 an embodiment is integrating with resulting in automatic lightweight two-way provisioning.

While the preferred embodiment of the invention has been illustrated and described, as noted above, many changes can be made without departing from the spirit and scope of the invention. Accordingly, the invention is not limited except as by the appended claims.

What is claimed is:

1. At least one computer-readable medium on which are stored instructions that, when executed by at least one processing device, enables the at least one processing device to perform a method comprising the steps of:
collecting data characterizing usage of a plurality of software applications hosted on a network by users of a set of at least one client device;
storing the collected data; and
determining, based on the stored data, at least one usage metric for at least one of the plurality of software applications.

2. The medium of claim 1, wherein the usage metric indicates type of usage by a client device of the set of at least one client device of a single software application of the plurality of software applications.

3. The medium of claim 1, wherein the usage metric indicates type of usage by the set of at least one client device of a single software application of the plurality of software applications.

4. The medium of claim 1, wherein the data is collected from logs associated with a firewall.

5. The medium of claim 1, wherein the data is collected via direct communication with the plurality of software applications.

6. The medium of claim 1, wherein the usage metric is determined using metadata specific to each software application of the plurality of software applications.

7. A system, comprising:
a collection module configured to collect data characterizing usage of a plurality of software applications hosted on a network by users of a set of client devices;
a data-storing module configured to store the collected data; and
a processing module configured to determine, based on the stored data, at least one usage metric for each of the plurality of software applications.

8. The system of claim 7, wherein the usage metric indicates type of usage by a client device of the set of client devices of a single software application of the plurality of software applications.

9. The system of claim 7, wherein the usage metric indicates type of usage by the set of client devices of a single software application of the plurality of software applications.

10. The system of claim 7, wherein the data is collected from logs associated with a firewall.

11. The system of claim 7, wherein the data is collected via direct communication with the plurality of software applications.

12. The system of claim 7, wherein the usage metric is determined using metadata specific to each software application of the plurality of software applications.

13. At least one computer-readable medium on which are stored instructions that, when executed by at least one processing device, enables the at least one processing device to perform a method comprising the steps of:
collecting data characterizing usage by a set of users on one side of a firewall of a plurality of software applications hosted on the other side of the firewall;
and
determining, based on the stored data, at least one usage metric for each of the plurality of software applications.

14. The medium of claim 13, wherein the usage metric indicates type of usage by a user of a single software application of the plurality of software applications.

15. The medium of claim 13, wherein the usage metric indicates type of usage by the set of users of a single software application of the plurality of software applications.

16. The medium of claim 13, wherein the data is collected from logs associated with the firewall.

17. The medium of claim 13, wherein the data is collected via direct communication with the plurality of software applications.

18. The medium of claim 13, wherein the usage metric is determined using metadata specific to each software application of the plurality of software applications.
